(19) United States
(12) Patent Application Publication
(10) Pub. No.: US 2008/0191979 A1
(43) Pub. Date: Aug. 14, 2008

(54) Display Control Device and Display Device

(76) Inventors: Masao Nakane, Saitama (JP); Takehiko Go, Saitama (JP); Yuji Takatori, Saitama (JP); Junya Ochi, Saitama (JP)

Correspondence Address: KRATZ, QUINTOS & HANSON, LLP, 1420 K Street, N.W., Suite 400, WASHINGTON, DC, 20005, US

(21) Appl. No.: 11/884,466

(22) PCT Filed: Feb. 17, 2006
(86) PCT No.: PCT/JP06/02798

§ 371 Date: Aug. 16, 2007

(30) Foreign Application Priority Data
Feb. 18, 2005 (JP) 2005-042849

(51) Int. Cl. G09G 3/36

(52) U.S. Cl. 345/87

(57) ABSTRACT

A red light sensor (222D), a green light sensor (232D), and a blue light sensor (242D) are provided on the LCD panel (200) of a display device (100). A processing section (170) of the display device (100) corrects, in an LCD correction control unit (173), a video image display state at positions corresponding to the red light sensor (222D), the green light sensor (232D), and the blue light sensor (242D) in the LCD panel (200) based on a state of outside light detected by the red light sensor (222D), the green light sensor (232D), and the blue light sensor (242D).

### TECHNICAL FIELD

The present invention relates to a display control device and a display device which adjust a display state of an image on a display unit.

### BACKGROUND ART

Conventionally, there is known a display control device which performs so-called dimmer control for adjusting a luminance of a display device according to light from outside (hereinafter, referred to as outside light) (for example, see Patent Document 1).

The display control device described in Patent Document 1 presets a cycle of reading a digital value obtained by converting an output from an optical sensor which detects the outside light and the like in a memory depending on an environment where the display control device is used. In this manner, by adjusting and changing the reading cycle according to the use environment, a speed of adjusting the luminance of a backlight to the outside light is adjusted.

[Patent Document 1] JP-A-2001-142446 (page 4, left column to right column)

### DISCLOSURE OF THE INVENTION

### Problems to be Solved by the Invention

With the configuration as described above, however, there is a fear in that a display state of the entire display area is adjusted to be approximately the same by adjusting the luminance of the backlight. Therefore, for example, there arises a problem in that, when intense outside light is radiated only on a part of the display area, there is a fear that the display state of only the area irradiated with the outside light is properly adjusted whereas the display state of a non-irradiated area is not properly adjusted.

The present invention has an object of providing a display control device and a display device, which can appropriately adjust a display state of an image on a display unit.

### Means for Solving the Problems

According to the present invention, there is provided a display control device for adjusting a display state of an image on a display unit including: a light state detecting unit that is provided at a predetermined position in a display area of the display unit and detects a state of light radiated from outside; and a display state adjusting unit that adjusts a display state of the image at the predetermined position based on the state of the light from the outside.

A display device according to an aspect of the present invention includes a display unit for displaying an image and the above-mentioned display control device according to the present invention.

### BRIEF DESCRIPTION OF THE DRAWINGS

FIG. 1 is a block diagram illustrating a schematic configuration of a display device according to an embodiment of the present invention;

FIG. 2 is a schematic view illustrating a schematic configuration of an LCD panel according to the embodiment;

FIG. 3 is a schematic view illustrating a schematic configuration of a red sub-pixel, a green sub-pixel, and a blue sub-pixel according to the embodiment;

FIG. 4 is a flowchart illustrating a video image display process according to the embodiment;

FIG. 5A is a graph indicating a red sensor value in each pixel when red outside light T is incident thereon according to the embodiment;

FIG. 5B is a graph indicating a green sensor value in each pixel when the red outside light T is incident thereon according to the embodiment;

FIG. 5C is a graph indicating a blue sensor value in each pixel when the red outside light T is incident thereon according to the embodiment;

FIG. 6 is a flowchart illustrating an LCD correction process according to the embodiment; and

FIG. 7 is a block diagram illustrating a schematic configuration of a display device according to another embodiment of the present invention.

### EXPLANATION OF CODES

100, 300: display device

110: display section serving as display unit

170: processing section constituting display control device

171: sensor average value calculating unit also functioning as display state adjusting unit

172: backlight correction control unit serving as display state adjusting unit

173: LCD correction control unit serving as display state adjusting unit also functioning as image mode recognizing unit

180: backlight serving as radiation unit

200: LCD panel serving as display area

210: pixel

220: red sub-pixel serving as first liquid crystal element

222C: color filter serving as red transmitting unit

222D: red light sensor serving as first light intensity detecting unit constituting display control device and light state detecting unit

223: liquid crystal

230: green sub-pixel serving as second liquid crystal element

232C: color filter serving as green transmitting unit

232D: green light sensor serving as second light intensity detecting unit constituting display control device and light state detecting unit

240: blue sub-pixel serving as third liquid crystal element

242C: color filter serving as blue transmitting unit

242D: blue light sensor serving as third light intensity detecting unit constituting display control device and light state detecting unit

### BEST MODE FOR CARRYING OUT THE INVENTION

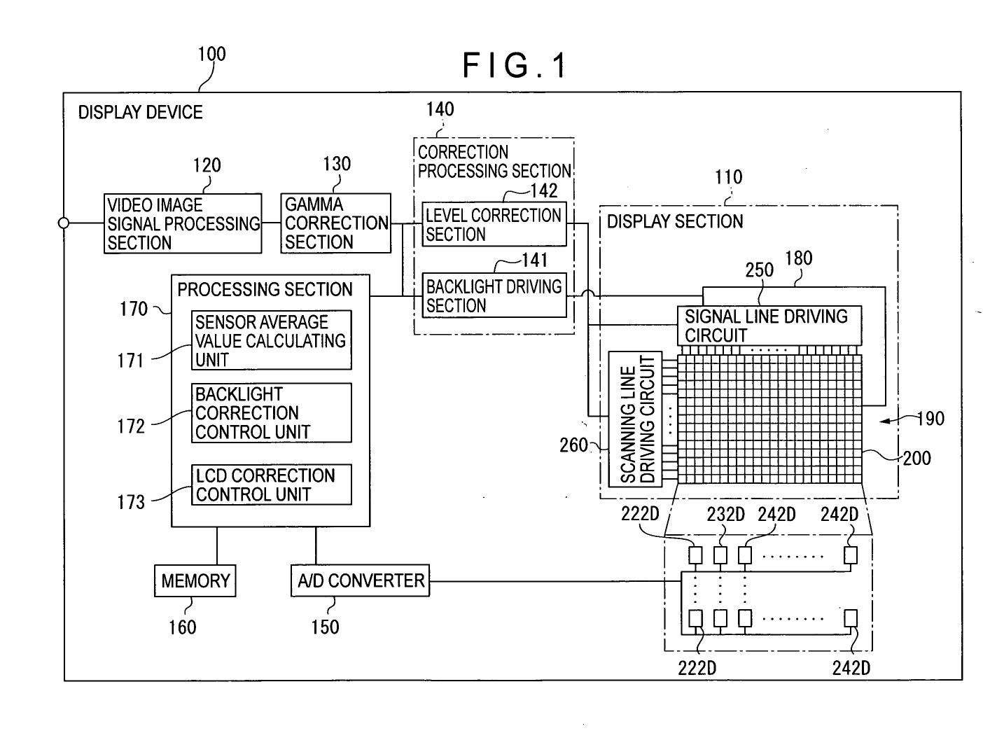

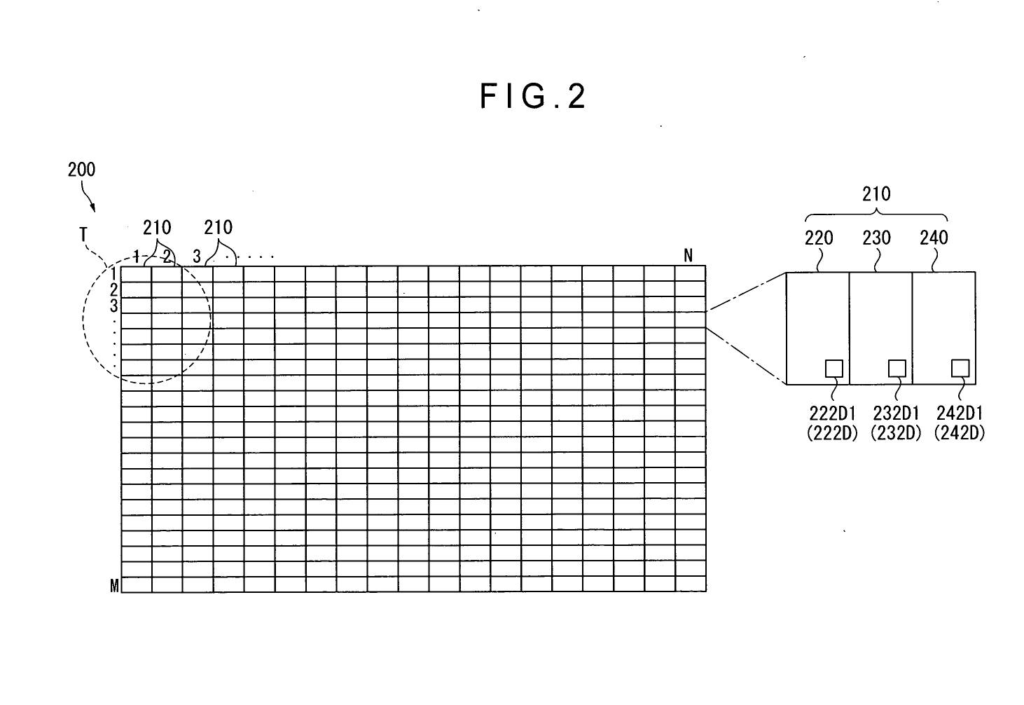

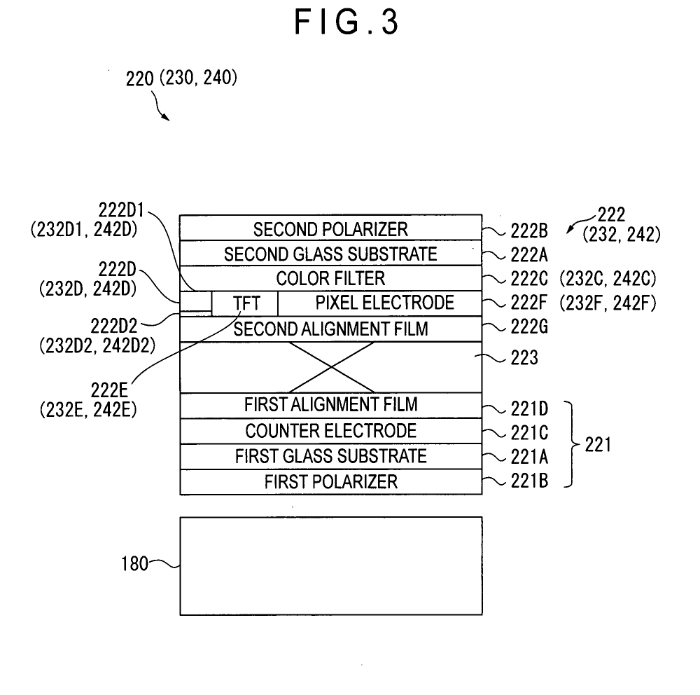

Hereinafter, an embodiment according to the present invention will be described with reference to the drawings. In this embodiment, a display device including a display control device according to the present invention, which is mounted in a mobile body, for example, a vehicle, to display map information, store information, a television image, or the like, is described as an example. It should be noted that the display device may not necessarily mounted in the vehicle. Any arrangement can be employed for the display device as long as the display device can display information. For example, the display device may be disposed at home, in a factory and in other places. FIG. 1 is a block diagram illustrating a schematic configuration of the display device. FIG. 2 is a schematic view illustrating a schematic configuration of an LCD panel. FIG. 3 is a schematic view illustrating a schematic configuration of a red sub-pixel, a green sub-pixel, and a blue sub-pixel.

### [Configuration of Display Device]

In FIG. 1, reference numeral 100 denotes a display device. The display device 100 appropriately displays a video image based on a video image signal output from a video image signal output device not shown in the drawings. The display device 100 appropriately corrects a display state of the video image based on, for example, light from a street lamp, light from a headlight of another vehicle, which is radiated from an outside of the display device 100 (hereinafter, referred to as outside light). The display device 100 includes a display section 110 serving as a display unit, a video image signal processing section 120, a gamma correction section 130, a correction processing section 140, an analog/digital (A/D) converting section 150, a memory 160, and a processing section 170.

The display section 110 is connected to the correction processing section 140 and the A/D converting section 150 to appropriately display the video image based on the video image signal from the video image signal output device. The display section 110 includes a backlight 180 serving as a radiation unit, and a liquid crystal display (LCD) section 190.

The backlight 180 is formed in an approximately rectangular plate-like shape, and appropriately radiates predetermined light from a back surface of the LCD section 190 toward the LCD section 190 by the control of the correction processing section 140. Specifically, the backlight 180 acquires, from the correction processing section 140, a radiated light setting signal indicating that light containing red, green, and blue light whose quantities are set to predetermined light quantities according to the outside light is to be radiated. Then, the backlight 180 radiates light corresponding to the radiated light setting signal toward the LCD section 190. It should be noted that description will be made referring to a surface of the backlight 180, from which light is output, as the surface of the backlight 180.

The LCD section 190 uses the light from the backlight 180 to appropriately display the video image based on the control of the correction processing section 140. The LCD section 190 includes an LCD panel 200 serving as a display area, a signal line driving circuit 250, and a scanning line driving circuit 260.

As illustrated in FIG. 2, the LCD panel 200 is formed in an approximately rectangular plate-like shape which is longer in a horizontal direction than in a longitudinal direction, and is provided on the surface side of the backlight 180. The LCD panel 200 includes (N×M) pixels 210; N pixels are arranged in the horizontal direction, whereas M pixels are arranged in the longitudinal direction (N and M are natural numbers). The pixel 210 which corresponds to a P-th pixel in the horizontal direction and corresponds to a Q-th pixel in the longitudinal direction on the LCD panel 200 with its upper left end in FIG. 2 being as a base point is appropriately referred to as the (P, Q) pixel 210 in the description. The pixel 210 adjusts a transmission state of the light radiated from the backlight 180 to output the light in a predetermined color by the control of the correction processing section 140. The pixel 210 includes a red sub-pixel 220 serving as a first liquid crystal element, a green sub-pixel 230 serving as a second liquid crystal element, and a blue sub-pixel 240 serving as a third liquid crystal element, which are horizontally arranged. The red sub-pixel 220, the green sub-pixel 230, and the blue sub-pixel 240 have approximately the same structure. Therefore, only the red sub-pixel 220 will be described in detail below, and the description of the green sub-pixel 230 and the blue sub-pixel 240 will be simplified.

The red sub-pixel 220 appropriately outputs the light from the backlight 180 in red at a predetermined intensity. As illustrated in FIG. 3, the red sub-pixel 220 includes a first substrate part 221, a second substrate part 222, and a liquid crystal 223.

The first substrate part 221 is provided so as to be adjacent to the surface of the backlight 180. The first substrate part 221 includes a first glass substrate 221A having approximately the same shape as the approximately rectangular shape of the LCD panel 200. On a surface of the first glass substrate 221A on the side of the backlight 180 (hereinafter, referred to as one side), for example, a first polarizer 221B having approximately the same shape as that of the first glass substrate 221A to polarize the light in a predetermined direction is deposited. On the surface of the first glass substrate 221A on the other side, a counter electrode 221C is provided. Furthermore, on the surface of the counter electrode 221C on the other side, for example, a first alignment film 221D having approximately the same shape as that of the first glass substrate 221A to align molecules of the liquid crystal 223 in a given direction is deposited.

The second substrate part 222 is provided on the other side of the first substrate part 221. The second substrate part 222 includes a second glass substrate 222A having approximately the same shape as that of the first glass substrate 221A. On the surface of the second glass substrate 222A on the other side, for example, a second polarizer 222B having approximately the same shape as that of the second glass substrate 222A, which polarizes the light in the direction approximately orthogonal to that of the first polarizer 221B, is deposited. Furthermore, on the surface of the second glass substrate 222A on one side, a color filter 222C serving as a red transmitting unit is deposited. On the surface of the color filter 222C on one side, a red light sensor 222D serving as a first light intensity detecting unit, a thin film transistor (TFT) 222E, and a pixel electrode 222F are arranged in one direction.

As illustrated in FIG. 1, the red light sensor 222D is connected to the A/D converting section 150. The red light sensor 222D includes, as illustrated in FIG. 3, a light receiving surface 222D1 provided on the color filter 222C side, which receives the outside light radiated through the color filter 222C, and a mask 222D2 provided on the side opposite to the light receiving surface 222D1, which shields the light radiated from the backlight 180. The red light sensor 222D detects the intensity of the light which is received on the light receiving surface 222D1 and is then transmitted through the color filter 222C, specifically, the intensity of red light contained in the outside light, and converts the detected intensity into a red sensor value Or to output the red sensor value as an analog signal to the A/D converter 150. The TFT 222E includes a source connected to the signal line driving circuit 250, a drain connected to the pixel electrode 222F, and a gate connected to the scanning line driving circuit 260. Upon input of a gate signal from the scanning line driving circuit 260, the TFT 222E causes the signal line driving circuit 250 to apply a predetermined voltage to the pixel electrode 222F and the counter electrode 221C. On one side of the mask 222D2, the TFT 222E, and the pixel electrode 222F, a second alignment film 222G for aligning the molecules of the liquid crystal 223 in a given direction approximately orthogonal to the direction of the alignment by the first alignment film 221D is deposited.

The liquid crystal 223 is provided between the first alignment film 221D and the second alignment film 222G. The molecules of the liquid crystal 223 are twisted at about 90 degrees, specifically, are aligned so as not to transmit the light from the backlight 180 by the first alignment film 221D and the second alignment film 222G when no voltage is applied to the pixel electrode 222F and the counter electrode 221C. Upon application of a predetermined voltage to the pixel electrode 222F and the counter electrode 221C, the alignment state of the molecules of the liquid crystal 223 is changed into a direction along an electric field according to the predetermined voltage, that is, into a state where the light from the backlight 180 is caused to transmit. As a result, the red sub-pixel 220 appropriately transmits the light from the backlight 180 through the liquid crystal 223 according to the voltage to output the light through the color filter 222C as red light at a predetermined intensity.

The green sub-pixel 230 appropriately outputs the light from the backlight 180 in green at a predetermined intensity. Then, the green sub-pixel 230 includes the first substrate part 221, a second substrate part 232, and the liquid crystal 223. On the second glass substrate 222A in the second substrate part 232, a color filter 232C serving as a green transmitting unit is deposited. On the color filter 232C, a green light sensor 232D serving as a second light intensity detecting unit, a TFT 232E, and a pixel electrode 232F are arranged. The green light sensor 232D includes a light receiving surface 232D1 and a mask 232D2, and detects the intensity of green light contained in the outside light received on the light receiving surface 232D1 to convert the intensity into a green sensor value Og and then output the green sensor value. Furthermore, the green sub-pixel 230 outputs the light from the backlight 180 as green light at a predetermined intensity through the color filter 232C according to the voltage applied to the pixel electrode 232F and the counter electrode 221C.

The blue sub-pixel 240 appropriately outputs the light from the backlight 180 in blue at a predetermined intensity. Then, the blue sub-pixel 240 includes the first substrate part 221, a second substrate part 242, and the liquid crystal 223. On the second glass substrate 222A in the second substrate part 242, a color filter 242C serving as a blue transmitting unit is deposited. On the color filter 242C, a blue light sensor 242D serving as a third light intensity detecting unit, a TFT 242E, and a pixel electrode 242F are arranged. The blue light sensor 242D includes a light receiving surface 242D1 and a mask 242D2, and detects the intensity of blue light contained in the outside light received on the light receiving surface 242D1 to convert the intensity into a blue sensor value Ob and then output the blue sensor value. Furthermore, the blue sub-pixel 240 outputs the light from the backlight 180 as blue light at a predetermined intensity through the color filter 242C according to the voltage applied to the pixel electrode 242F and the counter electrode 221C.

Then, the pixel 210 outputs light in a color obtained by mixing red, green, and blue light at the predetermined intensities respectively output from the red sub-pixel 220, the green sub-pixel 230, and the blue sub-pixel 240. It should be noted that the red light sensor 222D, the green light sensor 232D, and the blue light sensor 242D constitute a light state detecting unit according to the present invention.

The signal line driving circuit 250 is connected to the sources of the TFTs 222E, 232E, and 242E as described above. The signal line driving circuit 250 applies a predetermined voltage to the pixel electrodes 222F, 232F, and 242F and the counter electrode 221C through the predetermined TFTs 222E, 232E, and 242E. Specifically, the signal line driving circuit 250 acquires, from the correction processing section 140, a color correction signal indicating that red, green, and blue light is to be output at the intensities corrected according to the outside light in the predetermined red-sub pixel 220, green sub-pixel 230, and blue sub-pixel 240. Furthermore, the signal line driving circuit 250 acquires a first specifying signal for specifying the red sub-pixel 220, the green sub-pixel 230, and the blue sub-pixel 240. Then, the signal line driving circuit 250 applies a voltage corresponding to a red correction value Hr described below of the color correction signal through the TFT 222E to the pixel electrode 222F and the counter electrode 221C of the red sub-pixel 220 corresponding to the first specifying signal. The signal line driving circuit 250 applies voltages corresponding to the green correction value Hg and the blue correction value Hb described below in the color correction signal to the pixel electrodes 232F and 242F and the counter electrode 221C of the green sub-pixel 230 and the blue sub-pixel 240, respectively.

The scanning line driving circuit 260 is connected to the gates of the TFTs 222E, 232E, and 242E, as described above. The scanning line driving circuit 260 acquires a second specifying signal for specifying the red sub-pixel 220, the green sub-pixel 230, and the blue sub-pixel 240 from the correction processing section 140 to appropriately output gate signals to the TFTs 222E, 232E, and 242E of the red sub-pixel 220, the green sub-pixel 230, and the blue sub-pixel 240 corresponding to the second specifying signal.

The video image signal processing section 120 is connected to the gamma correction section 130. A video image information output device not shown in the drawings is removably connected to the video image signal processing section 120. The video image signal processing section 120 acquires, from the video image information output device, a video image signal for allowing the display section 110 to display a video image. Then, for example, the video image signal processing section 120 appropriately carries out an image quality adjustment process for adjusting a video image signal according to a brightness, contrast, a color density, and the like preset by a user. The video image signal processing section 120 appropriately converts the video image signal into a color setting signal for a red setting value Sr1 corresponding to red intensity setting, a green setting value Sg1 corresponding to green intensity setting, and a blue setting value Sb1 corresponding to blue intensity setting of the light output from each pixel 210, and then outputs the color setting signal to the gamma correction section 130.

The gamma correction section 130 is connected to the correction processing section 140 and the processing section 170. The gamma correction section 130 acquires the color setting signal from the video image signal processing section 120 to appropriately implement a so-called gamma correction process for the red setting value Sr1, the green setting value Sg1, and the blue setting value Sb1. Then, the gamma correction section 130 sets the red setting value Sr1, the green setting value Sg1, and the blue setting value Sb1, which are subjected to the gamma correction process, as a red adjustment value Sr2, a green adjustment value Sg2, and a blue adjustment value Sb2, respectively. Then, the gamma correction section 130 outputs a color adjustment signal for these values to the correction processing section 140 and the processing section 170.

The correction processing section 140 is connected to the processing section 170, and appropriately corrects a display state of the video image in the display section 10 by the control of the processing section 170. The correction processing section 140 includes a backlight driving section 141, and a level correction section 142.

The backlight driving section 141 causes the backlight 180 to appropriately radiate predetermined light. Specifically, the backlight driving section 141 appropriately acquires a light quantity signal for a red backlight light quantity (hereinafter, referred to as red BL light quantity) Lr, a green backlight light quantity (hereinafter, referred to as green BL light quantity) Lg, and a blue backlight light quantity (hereinafter, referred to as blue BL light quantity) Lb respectively corresponding to red, green, and blue light quantities in the light radiated from the backlight 180 according to the outside light, from the processing section 170. Then, the backlight driving section 141 generates a radiated light setting signal indicating the quantities of the red light, green light, and blue light in the light radiated from the backlight 180 are to be set to the red BL light quantity Lr, the green BL light quantity Lg, and the blue BL light quantity Lb of the light quantity signal, and outputs the generated radiated light setting signal to the backlight 180.

The level correction section 142 appropriately corrects the contrast and the color tone of the video image displayed on the LCD panel 200. Specifically, the level correction section 142 acquires the color adjustment signal from the gamma correction section 130. The level correction section 142 also acquires, from the processing section 170, a correction request signal indicating the red adjustment value Sr2, the green adjustment value Sg2, and the blue adjustment value Sb2 are to be corrected to the red correction value Hr, the green correction value Hg, and the blue correction value Hb corresponding to red, green, and blue appropriately corrected according to the outside light, and outputs the first specifying signal for specifying the red sub-pixel 220, the green sub-pixel 230, and the blue sub-pixel 240 together with a color correction signal for the correction values to the signal line driving circuit 250. The level correction section 142 also outputs the second specifying signal for specifying the red sub-pixel 220, the green sub-pixel 230, and the blue sub-pixel 240, which correspond to the color correction signal, to the scanning line driving circuit 260.

The A/D converting section 150 is connected to the processing section 170. The A/D converting section 150 acquires analog signals respectively from the red light sensor 222D, the green light sensor 232D, and the blue light sensor 242D, and converts the red sensor value Or, the green sensor value Og, and the blue sensor value Ob of the analog signals into a digital signal to output the digital signal to the processing section 170.

The memory 160 is connected to the processing section 170. The memory 160 appropriately stores information required for the video image display process in a readable manner. The memory 160 also stores various programs and the like expanded on an operating system (OS) which controls the operation of the entire display device 100.

The processing section 170 includes various input/output ports not shown in the drawings, for example, a gamma correction port to which the gamma correction section 130 is connected, a BL driving port to which the backlight driving section 141 is connected, a level correction port to which the level correction section 142 is connected, an A/D port to which the A/D converting section 150 is connected, and a memory port to which the memory 160 is connected. The processing section 170 includes various programs, as illustrated in FIG. 1, such as a sensor average value calculating unit 171 also functioning as a display state adjusting unit, a backlight correction control unit (hereinafter, referred to as a BL correction control unit) 172 serving as a display state adjusting unit, and an LCD correction control unit 173 serving as a display state adjusting unit also functioning as an image mode recognizing unit. The processing section 170, the red light sensor 222D, the green light sensor 232D, and the blue light sensor 242D constitute the display control device according to the present invention. The display control device according to the present invention may have a configuration in which at least any one of the sensor average value calculating unit 171 and the, BL correction control unit 172 is omitted.

The sensor average value calculating unit 171 appropriately calculates the respective average values of the red sensor value Or, the green sensor value Og, and the blue sensor value Ob for a predetermined time as a red sensor average value Ar, a green sensor average value Ag, and a blue sensor average value Ab. Specifically, the sensor average value calculating unit 171 acquires the red sensor value Or, the green sensor value Og, and the blue sensor value Ob output from the A/D converting section 150 as the digital signals to store the acquired digital signals in the memory 160. Then, for example, the red sensor values Or corresponding to all the pixels 210 output from the A/D converting section 150 in a predetermined time are acquired from the memory 160 to calculate a red sensor average value Ar of these red sensor values Or. In a similar manner, a green sensor average value Ag and a blue sensor average value Ab are respectively calculated based on the green sensor values Og and the blue sensor values Ob corresponding to all the pixels 210.

The BL correction control unit 172 controls to appropriately set a color of the light radiated from the backlight 180 according to the outside light. Specifically, the BL correction control unit 172 calculates a red BL light quantity Lr by multiplying the red sensor average value Ar by a proportionality constant Jr and then adding thereto a minimum light quantity Kr of the red light output from the backlight 180. The BL correction control unit 172 also calculates a green BL light quantity Lg and a blue BL light quantity Lb by multiplying the green sensor average value Ag and the blue sensor average value Ab by proportionality constants Jg and Jb and then adding thereto a minimum light quantity Kg of the green light and a minimum light quantity Kb of the blue light from the backlight 180, respectively. Then, the BL correction control unit 172 generates a light quantity signal for the red BL light quantity Lr, the green BL light quantity Lg, and the blue BL light quantity Lb to output the generated light quantity signal to the backlight driving section 141.

The LCD correction control unit 173 controls the operations of the red sub-pixel 220, the green sub-pixel 230, and the blue sub-pixel 240 of each pixel 210 to set the contrast or the color tone of the video image displayed on the LCD panel 200 according to the outside light. Specifically, the LCD correction control unit 173 acquires the color adjustment signal from the gamma correction section 130 to store the red adjustment value Sr2, the green adjustment value Sg2, and the blue adjustment value Sb2 in the memory 160. Then, the LCD correction control unit 173 sets the red adjustment value Sr2, the green adjustment value Sg2, and the blue adjustment value Sb2 as the red correction value Hr, the green correction value Hg, and the blue correction value Hb. The LCD correction control unit 173 also acquires the red sensor value Or corresponding to the red sub-pixel 220 of the predetermined pixel 210 from the memory 160 to calculate a red relative value Dr by dividing the red sensor value Or by the red sensor average value Ar. Furthermore, the LCD correction control unit 173 calculates the green relative value Dg of the green sub-pixel 230 and the blue relative value Db of the blue sub-pixel 240, which correspond to the red sub-pixel 220, in the same manner as that for the red relative value Dr. Then, after the recognition that the red relative value Dr, the green relative value Dg, and the blue relative value Db are all within an allowable range, for example, from 0.9 to 1.1, it is determined that the correction is not required because the contrast or the color tone of the pixel 210 is scarcely changed by the outside light. The allowable range is not limited to the above-mentioned range, and may appropriately be another range, for example, from 0.7 to 1.3, or from 0.8 to 1.4. Then, a correction request signal for the set red correction value Hr, green correction value Hg, and blue correction value Hb is output to the level correction section 142.

When the LCD correction control unit 173 recognizes that at least one of the red relative value Dr, the green relative value Dg, and the blue relative value Db is not within the allowable range, the LCD correction control unit 173 determines that a change in the contrast or the color tone of the pixel 210 due to the outside light is great and therefore correction is required. Furthermore, based on the red adjustment value Sr2, the green adjustment value Sg2, and the blue adjustment value Sb2, the LCD correction control unit 173 calculates a brightness X in the pixel 210 before the correction according to the outside light (hereinafter, referred to as pixel brightness X). Then, after recognizing that the pixel brightness X is less than a preset set value, specifically, a light output state, that is, a light emission state based on the red adjustment value Sr2, the green adjustment value Sg2, and the blue adjustment value Sb2 of the pixel 210, is darker than a preset state, the LCD correction control unit 173 determines that the contrast of the display image drops due to the reflection of the outside light in the pixel 210 to implement a contrast correction process. Specifically, after recognizing that the red relative value Dr is larger than 1.1 corresponding to the upper limit value, the LCD correction control unit 173 calculates a value by multiplying the red adjustment value Sr2 by the proportionality constant Cr and the red relative value Dr. Then, the LCD correction control unit 173 resets the obtained value as the red correction value Hr. Specifically, after recognizing that the intensity of red of the outside light incident on the pixel 210 is larger than the average intensity of red incident on all the pixels 210 by 10% or more, the LCD correction control unit 173 performs a process of increasing the light emission intensity of red of the pixel 210 to increase the contrast. After recognizing that the green relative value Dg and the blue relative value Db are larger than the upper limit value, the LCD correction control unit 173 resets values obtained by multiplying the green adjustment value Sg2 and the blue adjustment value Sb2 by the proportionality constants Cg and Cb, the green relative value Dg, and the blue relative value Db as the green correction value Hg and the blue correction value Hb, respectively.

Furthermore, after recognizing that the pixel brightness X is equal to or larger than the set value, specifically, the light emission state of the pixel 210 is brighter than the preset state, the LCD correction control unit 173 determines that a change in the color tone becomes greater due to the reflection of the outside light in the pixel 210 to carry out a color tone correction process. Specifically, after recognizing that the red relative value Dr is larger than the upper limit value, the LCD correction control unit 173 resets a value obtained by multiplying the red adjustment value Sr2 by the proportionality constant Ir and the red relative value Dr as the red correction value Hr. Specifically, after recognizing that the intensity of red incident on the pixel 210 is larger than the average intensity of red incident on all the pixels 210 by 10% or more, the LCD correction control unit 173 performs a process of reducing the light emission intensity of red of the pixel 210 to adjust the color tone. After recognizing that the green relative value Dg and the blue relative value Db are larger than the upper limit value, the LCD correction control unit 173 resets values obtained by multiplying the green adjustment value Sg2 and the blue adjustment value Sb2 by the proportionality constants Ig and Ib, the green relative value Dg, and the blue relative value Db as the green correction value Hg and the blue correction value Hb, respectively. Then, the LCD correction control unit 173 outputs a correction request signal for the red correction value Hr, the green correction value Hg, and the blue correction value Hb set by the process of correcting the contrast or the color tone to the level correcting section 142.

### [Operation of Display Device]

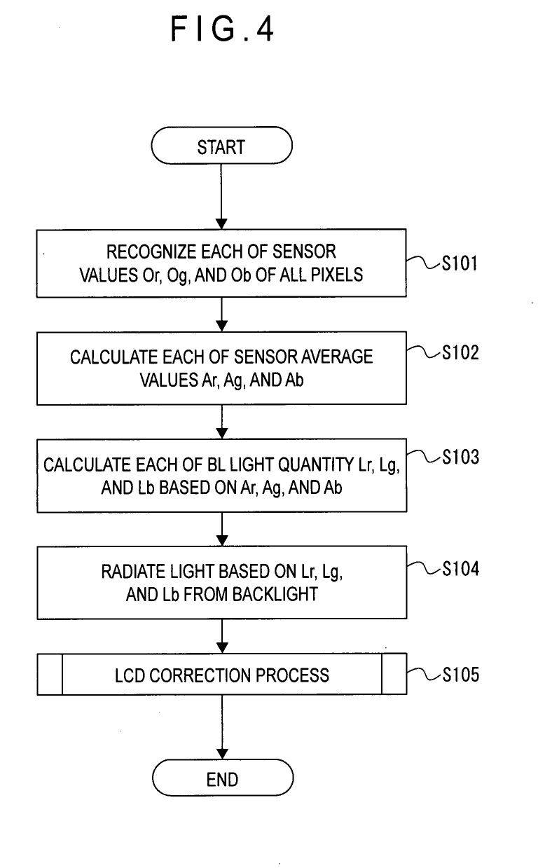

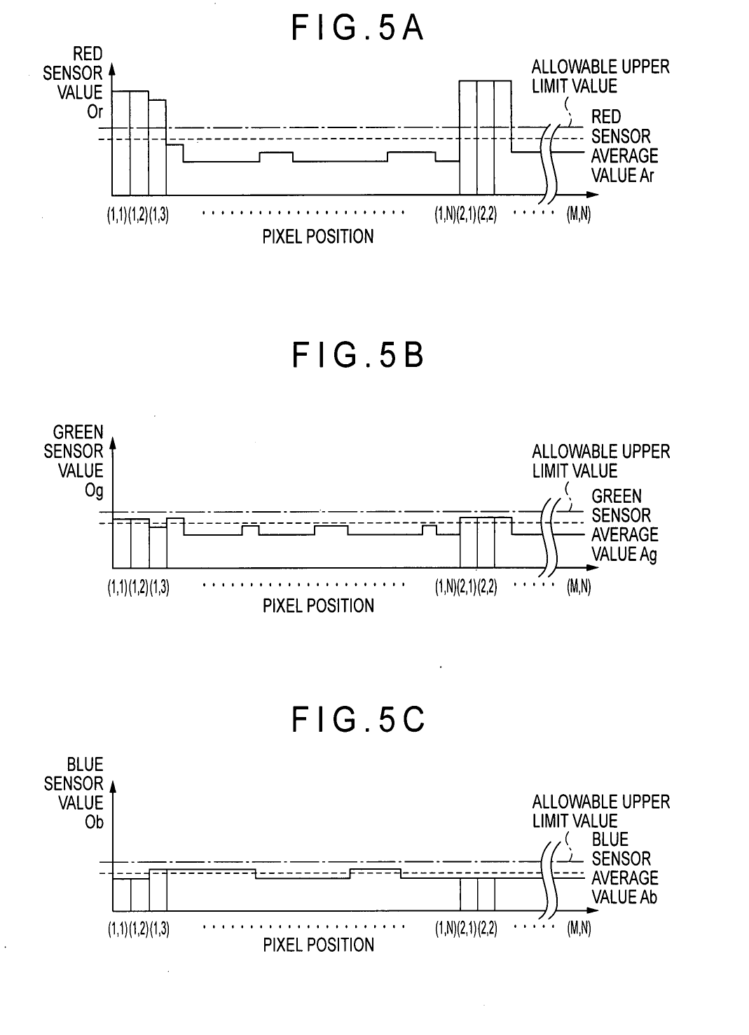

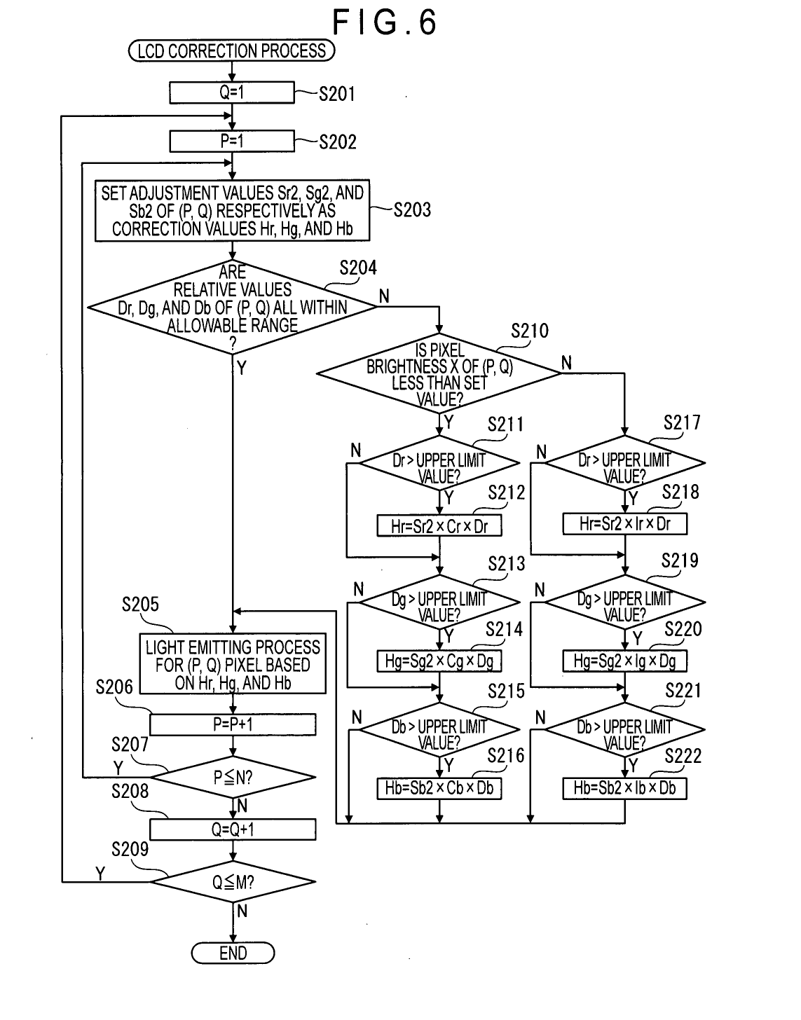

Next, a video image display process will be described as an operation of the display device 100 with reference to the drawings. Herein, a video image display process when red outside light T as illustrated in FIG. 2 is incident on the LCD panel 200 will be described as an example. FIG. 4 is a flowchart illustrating the video image display process. FIG. 5A is a graph indicating a red sensor value in each pixel when the red outside light T is incident thereon, FIG. 5B is a graph indicating a green sensor value in each pixel when the red outside light T is incident thereon, and FIG. 5C is a graph indicating a blue sensor value in each pixel when the red outside light T is incident thereon. FIG. 6 is a flowchart illustrating an LCD correction process.

First, after the video image signal processing section 120 acquires a video image signal of a predetermined video image output from the video image signal output device, the display device 100 detects the intensity of the red light contained in the outside light incident on the LCD panel 200 with the red light sensors 222D of all the pixels 210. Moreover, the display device 100 detects the intensity of the green light and that of the blue light contained in the outside light incident on the LCD panel 200 with the green light sensors 232D and the blue light sensors 242D of all the pixels 210. Then, the processing section 170 recognizes, as illustrated in FIG. 4, the red sensor value Or, the green sensor value Og, and the blue sensor value Ob respectively corresponding to the light intensities detected by the red light sensor 222D, the green light sensor 232D, and the blue light sensor 242D in the sensor average value calculating unit 171 (Step S101).

In this case, since the red outside light T as illustrated in FIG. 2 is incident on the LCD panel 200, the sensor average value calculating unit 171 recognizes, for example, as illustrated in FIG. 5A, the red sensor values Or of the pixels 210 such as (1, 1), (1,2), (1,3), and (2,1), on which the red outside light T is incident, are remarkably greater than those of the pixels 210 such as (1, 4) and (1, N) on which the red outside light T is not incident. Moreover, for example, as illustrated in FIGS. 5B and SC, the sensor average value calculating unit 171 recognizes that the green sensor values Og and the blue sensor values Ob of all the pixels 210 are approximately the same.

After that, the sensor average value calculating unit 171 calculates the red sensor average value Ar, the green sensor average value Ag, and the blue sensor average value Ab (Step S102). The processing section 170 calculates, in the BL correction control unit 172, the red BL light quantity Lb, the green BL light quantity Lg, and the blue BL light quantity Lb based on the red sensor average value Ar, the green sensor average value Ag, and the blue sensor average value Ab (Step S103). Then, the display device 100 radiates light containing the quantities of red light, green light, and blue light, which are set to the red BL light quantity Lb, the green BL light quantity Lg, and the blue BL light quantity Lb, from the backlight 180 toward the LCD panel 200 (Step S104). After that, the processing section 170 implements the LCD correction process (Step S105) and then terminates the video image display process.

On the other hand, in the LCD correction process, as illustrated in FIG. 6, the processing section 170 sets a variable Q to 1 (Step S201) and also sets a variable P to 1 (Step S202) in the LCD correction control unit 173. The gamma correction section 130 implements the gamma correction process and the like to set the red setting value Sr1, the green setting value Sg1, and the blue setting value Sb1 of each pixel 210 based on the video image signal as the red adjustment value Sr2, the green adjustment value Sg2, and the blue adjustment value Sb2. Then, the LCD correction control unit 173 sets the red adjustment value Sr2, the green adjustment value Sg2, and the blue adjustment value Sb2 of the (P, Q) pixel 210 as the red correction value Hr, the green correction value Hg, and the blue correction value Hb (Step S203). After that, the LCD correction control unit 173 determines whether or not the red relative value Dr, the green relative value Dg, and the blue relative value Db of the (P, Q) pixel are all within the allowable range (Step S204).

When it is determined in Step S204 that all the relative values are within the allowable range, the level correction section 142 causes the (P, Q) pixel 210 to emit red light, green light and blue light to correspond to the red correction value Hr, the green correction value Hg, and the blue correction value Hb (Step S205). In this case, when the process of Step S205 is implemented after the process of Step S204, light with the red correction value Hr, the green correction value Hg, and the blue correction value Hb being respectively set to the red adjustment value Sr2, the green adjustment value Sg2, and the blue adjustment value Sb2 is emitted, specifically, light is emitted without correcting the intensity of each of the colors. Then, the LCD correction control unit 173 adds 1 to the variable P (Step S206) and determines whether or not the variable P is equal to or less than N (Step S207). When the variable P is determined as being equal to or less than N in Step S207, the process returns to Step S203. On the other hand, when the variable P is determined as not being equal to or less than N in Step S207, the LCD correction control unit 173 adds 1 to the variable Q (Step S208) and determines whether or not the variable Q is equal to or less than M (Step S209). In Step S209, when it is determined that the variable Q is equal to or less than M, the process returns to Step S202. On the other hand, when it is determined that the variable Q is not equal to or less than M in Step S209, the LCD correction process is terminated. When it is determined in Step S204 that at least any one of the red relative value Dr, the green relative value Dg, and the blue relative value Db is not within the allowable range, the LCD correction control unit 173 determines whether or not the pixel brightness X of the (P, Q) pixel 210 is less than the set value (Step S210).

When it is determined in Step S210 that the pixel brightness X is less than the set value, it is determined whether or not the red relative value Dr is larger than its upper limit value (Step S211). When it is determined in Step S211 that the red relative value Dr is larger than the upper limit value, the red correction value Hr is set based on the proportionality constant Cr (Step S212). Then, it is determined whether or not the green relative value Dg is larger than its upper limit value (Step S213). On the other hand, when it is determined in Step S211 that the red relative value Dr is not larger than the upper limit value, the process of Step S213 is performed. When it is determined in Step S213 that the green relative value Dr is larger than its upper limit value, the green correction value Hg is set based on the proportionality constant Cg (Step S214). Then, it is determined whether or not the blue relative value Db is larger than its upper limit value (Step S215). On the other hand, when it is determined in Step S213 that the green relative value Dg is not larger than the upper limit value, the process of Step S215 is performed. When it is determined in Step S215 that the blue relative value Db is larger than its upper limit value, the blue correction value Hb is set based on the proportionality constant Cb (Step S216). Then, the process of Step S205 is performed. On the other hand, when it is determined in Step S215 that the blue relative value Db is not larger than the upper limit value, the process of Step S205 is performed.

In this case, as illustrated in FIGS. 5A, 5B, and 5C, the red sensor values Or of the pixels 210, on which the red outside light T is incident, are larger than the upper limit value. Therefore, the red correction values Hr of the pixels 210, on which the red outside light T is incident, of the pixels 210 having the pixel brightness X less than the set value are corrected to a value larger than the red adjustment value Sr2 based on the proportionality constant Cr. Moreover, the red sensor values Or of the pixels 210, on which the red outside light T is not incident, are smaller than the upper limit value. Therefore, the red correction values Hr of the pixels 210, on which the red outside light T is not incident, of the pixels 210 having the pixel brightness X less than the set value, are not corrected. Furthermore, since the green sensor values Og and the blue sensor values Ob of all the pixels 210 having the pixel brightness X less than the set value are smaller than their upper limit values, the green correction value Hg and the blue correction value Hb of the pixel 210 are not corrected. Then, the pixels 210, on which the red outside light T is incident, of the pixels 210 having the pixel brightness X less than the set value are caused to emit light in a color which is corrected to increase only the intensity of red. Moreover, the pixels 210, on which the red outside light T is not incident, of the pixels 210 having the pixel brightness X less than the set value are caused to emit light without correcting the intensity of each color.

Then, when it is determined in Step S210 that the pixel brightness X is equal to or larger than the set value, it is determined whether the red relative value Dr is larger than its upper limit value (Step S217). When it is determined in Step S217 that the red relative value Dr is larger than the upper limit value, the red correction value Hr is set based on the proportionality constant Ir (Step S218). Then, it is determined whether or not the green relative value Dg is larger than its upper limit value (Step S219). On the other hand, when it is determined in Step S217 that the red relative value Dr is not larger than the upper limit value, the process of Step S219 is performed. When it is determined in Step S219 that the green relative value Dg is larger than the upper limit value, the green correction value Hg is set based on the proportionality constant Ig (Step S220). Then, it is determined whether or not the blue relative value Db is larger than its upper limit value (Step S221). On the other hand, when it is determined in Step S219 that the blue relative value Db is not larger than the upper limit value, the process of Step S221 is performed. When it is determined in Step S211 that the blue relative value Db is larger than the upper limit value, the blue correction value Hb is set based on the proportionality constant Ib (Step S222). Then, the process of Step S205 is performed. On the other hand, when it is determined in Step S221 that the blue relative value Db is not larger than the upper limit value, the process of Step S205 is performed.

Herein, the red correction values Hr of the pixels 210, on which the red outside light T is incident, of the pixels 210 having the pixel brightness X equal to or larger than the set value are corrected based on the proportionality constant Ir to be smaller than the red adjustment value Sr2. The red correction values Hr of the pixels 210, on which the red outside light T is not incident, of the pixels 210 having the pixel brightness X equal to or larger than the set value are not corrected. Furthermore, the green correction values Hg and the blue correction values Hb of all the pixels 210 having the pixel brightness X equal to or larger than the set value are not corrected. Then, the pixels 210, on which the red outside light T is incident, of the pixels 210 having the pixel brightness X equal to or larger than the set value are caused to emit light at the intensity reduced only for red. The pixels 210, on which the red outside light T is not incident, of the pixels 210 having the pixel brightness X equal to or larger than the set value are caused to emit light without correcting the intensity of each color.

### [Effects of Display Device]

As described above, in the above-mentioned embodiment, the red light sensors 222D, the green light sensors 232D, and the blue light sensors 242D for detecting a state of the outside light, for example, that of a headlight of another vehicle, are provided for the LCD panel 200 of the display device 100. The processing section 170 of the display device 100 corrects the video image display state at the position corresponding to the red light sensor 222D, the green light sensor 232D, and the blue light sensor 242D of the LCD panel 200 based on the state of the outside light detected by the red light sensor 222D, the green light sensor 232D, and the blue light sensor 242D in the LCD correction control unit 173. Therefore, when the red outside light T, for example, as illustrated in FIG. 2, is incident on the LCD panel 200, the display device 100 can correct the video image display state only at the position, at which the red outside light T is incident, based on the detected state of the red outside light T in the red light sensor 222D, the green light sensor 232D, and the blue light sensor 242D at the position at which the red outside light T is incident. Moreover, since the display device 100 directly detects the state of the outside light incident on the LCD panel 200 with the red light sensor 222D provided for the LCD panel 200 or the like, the state of the outside light can be more appropriately detected as compared with the structure of detecting the state of the outside light incident on the LCD panel 200 with sensors provided at the positions apart from the LCD panel 200, for example, at the positions around the LCD panel 200. Thus, the display device 100 can appropriately adjust the video image display state.

Furthermore, the LCD correction control unit 173 calculates the pixel brightness X in each pixel 210 according to the outside light before the correction. Then, the LCD correction control unit 173 corrects the video image display state based on the detected state of the outside light in the red light sensor 222D, the green light sensor 232D, and the blue light sensor 242D and on the pixel brightness X, specifically, the light emission state of the pixel 210 before the correction. Therefore, the display device 100 can correct the video image display state to correspond to the light emission state of the pixel 210 according to the outside light before the correction, specifically, the brightness of the video image according to the outside light before the correction. Therefore, the display device 100 can more appropriately adjust the video image display state.

Moreover, after recognizing that the pixel brightness X is less than the set value, specifically, the light emission state of the pixel 210 is darker than the preset state, the LCD correction control unit 173 determines that the contrast drops due to the reflection of the outside light in the pixel 210. Therefore, the LCD correction control unit 173 performs the contrast correction process of increasing the light emission intensity of the color corresponding to the color of the outside light in the pixel 210. For example, when the red outside light T is incident on the pixel 210 corresponding to a dark part of the video image, the contrast correction process of increasing the red light emission intensity of the pixel 210 is performed. Therefore, even when the outside light is incident on the dark part of the video image, specifically, the outside light is incident so as to drop the contrast of the video image, the display device 100 can correct the video image so as not to drop the contrast of the dark part. Therefore, the display device 100 can more appropriately adjust the video image display state.

After recognizing that the pixel brightness X is equal to or larger than the set value, specifically, the light emission state of the pixel 210 is brighter than the preset state, the LCD correction control unit 173 determines that the color tone greatly changes due to the reflection of the outside light in the pixel 210. Therefore, the LCD correction control unit 173 performs the color tone correction process of decreasing the light emission intensity of the color in the pixel 210, which corresponds to the color of the outside light. For example, when the red outside light T is incident on the pixel 210 corresponding to a bright part of the video image, the color tone correction process of decreasing the red light emission intensity of the pixel 210 is performed. Therefore, when the outside light is incident on the bright part of the video image, specifically, the outside light is incident to increase the change in the color tone of the video image, the display device 100 can correct the video image to keep the color tone change of the bright part small. Therefore, the display device 100 can more appropriately adjust the video image display state.

Furthermore, the red light sensors 222D, the green light sensor 232D, and the blue light sensors 242D are provided at a plurality of positions on the LCD panel 200, which are different from each other. Therefore, even when the outside light is incident on the area containing the plurality of positions, the display device 100 can correct the light emission states at all the positions in the area according to the outside light. Moreover, even when outside light in different colors are incident at a plurality of positions apart from each other, the light emission states at the plurality of positions can be corrected according to the outside light. Therefore, the display device 100 can more appropriately adjust the video image display state.

Furthermore, the red light sensor 222D, the green light sensor 232D, and the blue light sensor 242D are provided for the pixel 210. Therefore, by correcting the light emission state per pixel 210, the display device 100 can more finely adjust the video image display state.

Furthermore, the red light sensor 222D, the green light sensor 232D, and the blue light sensor 242D are provided respectively for the red sub-pixel 220, the green sub-pixel 230, and the blue sub-pixel 240 whose light emission states can be corrected by the liquid crystal 223. Specifically, the red light sensors 222D, the green light sensors 232D, and the blue light sensors 242D are provided for the LCD panel 200. As a result, the LCD panel 200 capable of appropriately adjusting the video image display state can be provided.

Then, the LCD panel 200 transmits the light from the backlight 180 through the red sub-pixels 220, the green sub-pixels 230, and the blue sub-pixels 240 to output the light as red light, green light and blue light. The red light sensor 222D, the green light sensor 232D, and the blue light sensor 242D detect the intensities of red, green, and blue of the outside light incident on the red sub-pixel 220, the green sub-pixel 230, and the blue sub-pixel 240, respectively. Then, the LCD correction control unit 173 sets the intensities of red, green, and blue to be output respectively from the red sub-pixel 220, the green sub-pixel 230, and the blue sub-pixel 240 based on the intensities of the colors respectively detected by the red light sensor 222D, the green light sensor 232D, and the blue light sensor 242D. Thus, the display device 100 can appropriately adjust the color video image display state. Furthermore, a so-called transmissive LCD-panel 200 capable of appropriately adjusting the color video image display state can be provided.

Furthermore, the BL correction control unit 172 corrects the state of the light radiated from the backlight 180 based on the state of the outside light detected by the red light sensor 222D, the green light sensor 232D, and the blue light sensor 242D. Therefore, the display device 100 can more finely correct the light emission state of the pixel 210 by the correction of the light transmission state through the liquid crystal 223 and the state of the light radiated from the backlight 180. Accordingly, the display device 100 can more finely adjust the video image display state.

The sensor average value calculating unit 171 calculates the red sensor average value Ar of the red sensor value Or, the green sensor average value Ag of the green sensor value Og, and the blue sensor average value Ab of the blue sensor value Ob respectively detected by the red light sensor 222D, the green light sensor 232D, and the blue light sensor 242D. The LCD correction control unit 173 calculates the red relative value Dr by dividing the red sensor value Or by the red sensor average value Ar, the green relative value Dg by dividing the green sensor value Og by the green sensor average value Ag, and the blue relative value Db by dividing the blue sensor value Ob by the blue sensor average value Ab, where the red sensor value Or, the green sensor value Og, and the blue sensor value Ob correspond to the predetermined pixel 210. Then, after recognizing that the red relative value Dr, the green relative value Dg, and the blue relative value Db are within the allowable range, specifically, the color of the outside light incident on the predetermined pixel 210 is approximately the same as the average color of the outside light incident on the LCD panel 200, the LCD correction control unit 173 does not correct the light transmission state of the pixel 210 in the liquid crystal 223. On the other hand, after recognizing that the color of the outside light incident on the predetermined pixel 210 is approximately the same as the average color of the outside light incident on the LCD panel 200, the BL correction control unit 172 corrects the state of the light radiated from the backlight 180. Therefore, when the color of the outside light incident on the predetermined pixel 210 is approximately the same as the average color of the outside light incident on the LCD panel 200, and therefore, the light emission state of the predetermined pixel 210 can be corrected to be the same as that of the other pixels 210, the display device 100 can correct the light emission state of each pixel 210 to the same level by the correction of the state of the light radiated from the backlight 180. Therefore, the display device 100 can more easily correct the light emission state of the entire screen as compared with the structure of correcting the light transmission state through the liquid crystal 223 in each pixel 210.

### [Variation of Embodiments]

It should be noted that the present invention is not limited to the embodiment described above. The present invention encompasses the following variation within the scope of enabling the achievement of the object of the present invention.

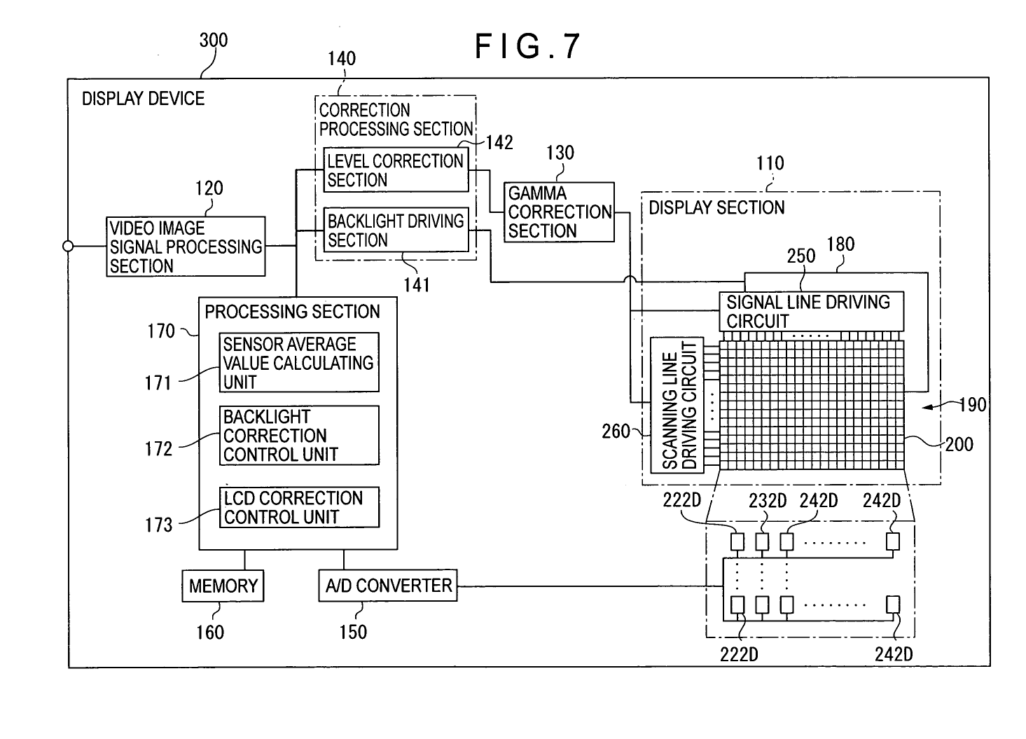

Specifically, the display device 100 for outputting the color setting signal processed in the video image signal processing section 120 to the gamma correction section 130 and then outputting the color adjustment signal corrected in the gamma correction section 130 to the level correction section 142 has been described. As illustrated in FIG. 7, however, a display device 300 may output the color setting signal processed in the video image signal processing section 120 to the correction processing section 140 and the processing section 170. In such a structure, the level correction section 142 in the correction processing section 140 acquires the color setting signal from the video image signal processing section 120, corrects the red setting value Sr1, the green setting value Sg1, and the blue setting value Sb1 to the red correction value Hr, the green correction value Hg, and the blue correction value Hb, which are appropriately corrected according to the outside light, in response to the correction request signal from the processing section 170, and then outputs the color correction signal for the correction values to the gamma correction section 130. Then, after implementing the gamma correction process on the color correction signal, the gamma correction section 130 outputs the color correction signal together with the first specifying signal to the signal line driving circuit 250. Then, the gamma correction section 130 outputs the second specifying signal for the color correction signal to the scanning line driving circuit 260.

The correction of the video image display state may be omitted based on the light emission state of the pixel 210 according to the outside light before the correction. For example, when the red outside light T is radiated on the predetermined pixel 210, the intensity of the red light emission of the pixel 210 may be controlled to be increased or decreased regardless of the light emission state of the pixel 210 before the correction. In such a structure, when it is determined in Step S204 that at least any one of the red relative value Dr, the green relative value Dg, and the blue relative value Db is not within the allowable range, the process of Step S211 or S216, or the process of Step S217 or S222 is implemented. As a result, a processing load in the LCD correction process can be decreased. Moreover, since it is no longer necessary to provide the function of calculating the pixel brightness X for the LCD correction control unit 173, the configuration of the LCD correction control unit 173 can be simplified.

The contrast correction process for the dark part when the outside light is incident on the dark part of the video image may be omitted. In such a structure, when it is determined in Step S210 that the pixel brightness X of the (P, Q) pixel 210 is less than the set value, the process of Step S205 is implemented. As a result, a processing load in the LCD correction process can be reduced. Moreover, since it is no longer necessary to provide the function of implementing the contrast correction process for the LCD correction control unit 173, the configuration of the LCD correction control unit 173 can be simplified.

Furthermore, the color tone correction process in the bright part when the outside light is incident on the bright part of the video image may be omitted. In such a structure, when it is determined in Step S210 that the pixel brightness X of the (P, Q) pixel 210 is equal to or larger than the set value, the process of Step S205 is implemented. As a result, a processing load in the LCD correction process can be reduced. Moreover, since it is no longer necessary to provide the function of implementing the color tone correction process for the LCD correction control unit 173, the configuration of the LCD correction control unit 173 can be simplified.

Moreover, in increasing the light emission intensity of, for example, the red light of the pixel 210, instead of increasing the absolute value of the light emission intensity of the red light, the light emission intensities of the green light and the blue light may be reduced to relatively increase the red light emission intensity. Moreover, in decreasing the light emission intensity of, for example, the green light of the pixel 210, instead of decreasing the light emission intensity of the green light, the light emission intensities of the red light and the blue light may be increased to relatively decrease the light emission intensity of the green light. Even in such structures, the display device 100 can implement the contrast or color tone correction process for a predetermined part in the same manner as in the above-mentioned embodiment even when the outside light is incident on the predetermined part of the video image to drop the contrast or to greatly change the color tone. As a result, the video image display state can be appropriately adjusted.

Furthermore, for example, the red light sensor 222D, the green light sensor 232D, and the blue light sensor 242D may be provided only at a predetermined position on the LCD panel 200. Even in such a structure, the video image display state at the predetermined position at which the red light sensor 222D or the like is provided can be corrected according to the outside light. Therefore, the display device 100 can appropriately adjust the video image display state as compared with the conventional structure of adjusting the video image display state only by the luminance adjustment of the backlight.

Moreover, instead of interposing the red light sensor 222D, the green light sensor 232D, and the blue light sensor 242D between the liquid crystal 223 and the color filters 222C, 232C, and 242C, the following structure may be used. Specifically, sensors for detecting the red light intensity, the green light intensity, and the blue light intensity may be provided on the side closer to the surface of the LCD panel 200 from the color filters 222C, 232C, and 242C, for example, on the surface of the LCD panel 200 or between the second glass substrate 222A and the second polarizer 222B. Furthermore, a single sensor for detecting the red light intensity, the green light intensity, and the blue light intensity may be provided, for example, to be closer to the surface of the red sub-pixel 220 from the color filter 222C in the pixel 210. Even in such a structure, the display device 100 can detect the color of the outside light incident on each of the pixels 210 with the sensor and appropriately adjust the video image display state according to the detected color of the outside light. Moreover, by providing a single sensor for detecting the red light intensity, the green light intensity, and the blue light intensity for the pixel 210, the number of sensors provided for the pixel 210 can be reduced as compared with the structure of the above-mentioned embodiment. As a result, the configuration of the pixel 210 can be simplified.

Furthermore, only any one or two of the red light sensor 222D, the green light sensor 232D, and the blue light sensor 242D may be provided for the pixel 210. Even in such a structure, the display device 100 can appropriately adjust the video image display state according to the color(s) of all the colors contained in the outside light, which can be detected by the sensor(s) provided for the pixel 210. Moreover, since the number of sensors provided for the pixel 210 can be reduced as compared with the structure of the above-mentioned embodiment, the configuration of the pixel 210 can be simplified.

Although the above-embodiment has been described using the backlight 180 capable of adjusting the color of light, the backlight is not limited thereto. A backlight which is not capable of adjusting the color of light, such as a cold-cathode tube or a white LED, may be used. In this case, a calculation of multiplying each of the sensor average values Ar, Ag, and Ab of the sensor values Or, Og, and Ob obtained by the red light sensor, the green light sensor, and the blue light sensor by a predetermined factor indicating the brightness of each of red, green, and blue and then adding the results of multiplication is performed to obtain a value indicating the intensity of the outside light. According to the obtained value, the intensity of the light is adjusted.

Furthermore, in the above-mentioned embodiment, the red light sensor 222D, the green light sensor 232D, the blue light sensor 242D are provided on the side on which the outside light is incident through the color filter 222C. However, the outside light sensors may be provided on the side of the surface of the color filter, specifically, on the side on which the outside light is incident without passing through the color filter 222C. In this structure, only the intensity of the outside light is detected regardless of the color of the outside light. In this case, the red adjustment value Sr, the green adjustment value Sg, and the blue adjustment value Sb are uniformly corrected to correct only the contrast. Moreover, the intensity of light from the backlight 180 may be controlled according to the correction.

Furthermore, the correction of the state of light radiated from the backlight 180 based on the state of the outside light may be omitted. In such a structure, after the process of Step S102, the process of Step S105 is implemented. Therefore, a processing load in the video image display process can be reduced. Since it is no longer necessary to provide the BL correction control unit 172 for the processing section 170, the configuration of the processing section 170 can be simplified.

Furthermore, the light transmission state through the liquid crystal 223 in the pixel 210 may be corrected even when the color of the outside light incident on the predetermined pixel 210 is approximately the same as the average color of the outside light incident on the LCD panel 200. In such a structure, after the process of Step S203, the process of Step S210 is implemented. Therefore, a processing load in the LCD correction process can be reduced. Furthermore, it is no longer necessary to provide the function of comparing the red relative value Dr or the like with the upper limit value or the lower limit value. Therefore, the configuration of the LCD correction control unit 173 can be simplified.

Moreover, the application of the present invention is not limited to the display device 100 including the transmission type LCD panel 200. The present invention may be applied to, for example, display devices as follows. Specifically, the present invention may be applied to a display device including a so-called reflective or semi-transmissive LCD panel which reflects incident light to output a video image, an organic electro luminescence (EL) panel, a plasma display panel (PDP), a cathode-ray tube (CRT), a field emission display (FED), and an electrophoretic display panel, and further, a display device for displaying a video image by a light emission unit such as a plurality of light-emitting diodes. Moreover, the application of the present invention is not limited to the display device for color display. The present invention may be applied to a display device for black and white display. Furthermore, the application of the present invention is not limited to an in-vehicle display device. The present invention may be applied to a portable display device, a display device installed in home or a factory, and a display device installed outdoors such as on a playing field. Furthermore, the present invention may be applied to, for example, a display section for displaying information such as a reproduction state or a recording state in a recording/reproducing device of video images or music.

Although each of the above-mentioned functions is constructed as a program, for example, each of the functions may be constructed by hardware such as a circuit board or an element such as a single IC (Integrated Circuit) and may be used as any form. It should be noted that by independently reading the programs from a recording medium, the display device is easy to handle, thereby easily implementing the expansion of use.

Besides, the specific structure and procedure for carrying out the present invention can be appropriately changed to another structure or the like within the scope of enabling the achievement of the object of the present invention.

### [Effects of Embodiments]

As described above, in the above-mentioned embodiment, the red light sensor 222D, the green light sensor 232D, and the blue light sensor 242D are provided for the LCD panel 200 of the display device 100. The processing section 170 of the display device 100 corrects the video image display state at the positions on the LCD panel 200, which corresponds to the red light sensor 222D, the green light sensor 232D, and the blue light sensor 242D, based on the state of the outside light detected by the red light sensor 222D, the green light sensor 232D, and the blue light sensor 242D in the LCD correction control unit 173. Therefore, when the red outside light T, for example, as illustrated in FIG. 2, is incident on the LCD panel 200, the display device 100 can correct the video image display state only at the position at which the red outside light T is incident, based on the detected state of the red outside light T in the red light sensor 222D, the green light sensor 232D, and the blue light sensor 242D at the position at which the red outside light T is incident. Moreover, since the display device 100 directly detects the state of the outside light incident on the LCD panel 200 with the red light sensor 222D provided for the LCD panel 200 and the like, the display device 100 can more appropriately detect the state of the outside light as compared with the structure of detecting the state of the outside light incident on the LCD panel 200 with the sensor provided at the position away from the LCD panel 200, for example, around the LCD panel 200. Thus, the display device 100 can appropriately adjust the video image display state.

### INDUSTRIAL APPLICABILITY

The present invention can be used for a display control device and a display device, which adjust an image display state on a display unit.

1-12. (canceled)

13. A display control device that adjusts a display state of an image on a display unit, comprising:
a light state detecting unit that is provided at a predetermined position in a display area of the display unit and detects a state of light radiated from an outside;
a display state adjusting unit that adjusts the display state of the image at the predetermined position based on the state of the light from the outside; and
an image mode recognizing unit that recognizes an intensity setting of an image signal of the image displayed at the predetermined position, wherein
the display state adjusting unit adjusts the display state of the image at the predetermined position based on the intensity setting of the image signal at the predetermined position and the state of the light from the outside.

14. The display control device according to claim 13, wherein
the light state detecting unit detects a color of the light from the outside as the state of the light,
the image mode recognizing unit recognizes a brightness based on the intensity setting of the image signal, and
upon recognition that the brightness of the image at the predetermined position is lower than a predetermined brightness, the display state adjusting unit performs adjustment to increase an intensity of a color in the image, which corresponds to the color of the light from the outside.

15. The display control device according to claim 13, wherein
the light state detecting unit detects the color of the light from the outside as the state of the light,
the image mode recognizing unit recognizes a brightness based on the intensity setting of the image signal, and
upon recognition that the brightness of the image at the predetermined position is higher than a predetermined brightness, the display state adjusting unit performs adjustment to decrease the intensity of the color in the image, which corresponds to the color of the light from the outside.

16. The display control device according to claim 13, wherein
the light state detecting unit is provided at each of a plurality of predetermined positions in the display area, which are different from each other.

17. The display control device according to claim 13, wherein
the display area includes a plurality of pixels to output light in a predetermined color,
the light state detecting unit is provided on each of the plurality of pixels at predetermined positions, and
the display state adjusting unit adjusts an output state of light in a predetermined color in the plurality of pixels at the predetermined position to adjust the display state of the image.

18. The display control device according to claim 17, wherein
each of the plurality of pixels includes a liquid crystal element that adjusts at least one of a transmission state and a reflection state of the radiated light to output the light in the predetermined color,
the light state detecting unit is provided to the liquid crystal element at a predetermined position, and
the display state adjusting unit adjusts the at least one of the transmission state and the reflection state in the liquid crystal element at the predetermined position to adjust the output state of the light in the predetermined color of the plurality of pixels.

19. The display control device according to claim 18, wherein
the display unit includes a radiation unit that radiates light through the plurality of pixels to the outside,
each of the plurality of pixels further includes:
a first liquid crystal element that transmits the light radiated from the radiation unit to output the radiated light as red light;
a second liquid crystal element that transmits the light radiated from the radiation unit to output the radiated light as green light; and
a third liquid crystal element that transmits the light radiated from the radiation unit to output the radiated light as blue light,
the light state detecting unit detects the color of the light from the outside as the state of the light, and
the display state adjusting unit adjusts the transmission state of the radiated light in the liquid crystal element based on the color of the light from the outside at the predetermined position to adjust the output state of the light in the predetermined color in the plurality of pixels.

20. The display control device according to claim 19, wherein
the first liquid crystal element includes liquid crystal that adjusts the transmission state of the radiated light and a red transmission unit that is provided on the side of the liquid crystal closer to the outside and transmits red light,
the second liquid crystal element comprises the liquid crystal and a green transmission unit that is provided on the side of the liquid crystal closer to the outside and transmits green light,
the third liquid crystal element comprises the liquid crystal and a blue transmission unit that is provided on the side of the liquid crystal closer to the outside and transmits blue light,
the light state detecting unit includes:
a first light intensity detecting unit that is provided between the liquid crystal and the red transmission unit and detects an intensity of the red light from the outside, the red light being transmitted through the red transmission unit;
a second light intensity detecting unit that is provided between the liquid crystal and the green transmission unit and detects an intensity of the green light from the outside, the green light being transmitted through the green transmission unit; and
a third light intensity detecting unit that is provided between the liquid crystal and the blue transmission unit and detects an intensity of the blue light from the outside, the blue light being transmitted through the blue transmission unit, and
the display state adjusting unit adjusts the transmission state of the light radiated on the liquid crystal based on the color of the light from the outside, which is specified based on the intensity of the red light, the intensity of the green light, and the intensity of the blue light at the predetermined position.

21. The display control device according to claim 19, wherein
the display state adjusting unit adjusts a radiation state of the light radiated from the radiation unit based on the color of the light from the outside, which is detected by the light state detecting unit, to adjust the output state of the light in the predetermined color in the plurality of pixels.

22. The display control device according to claim 21, wherein
the light state detecting unit is provided to each of the plurality of the pixels different from each other, and
the display state adjusting unit does not adjust the transmission state of the radiated light in the liquid crystal element upon recognition that an average color of the light from the outside detected by the light state detecting units and the color of the light from the outside at the predetermined position are substantially the same.

23. A display device, comprising:
a display unit that displays an image; and
a display control device that adjusts a display state of an image on a display unit, the display control device including:
a light state detecting unit that is provided at a predetermined position in a display area of the display unit and detects a state of light radiated from an outside;
a display state adjusting unit that adjusts the display state of the image at the predetermined position based on the state of the light from the outside; and
an image mode recognizing unit that recognizes an intensity setting of an image signal of the image displayed at the predetermined position, wherein
the display state adjusting unit adjusts the display state of the image at the predetermined position based on the intensity setting of the image signal at the predetermined position and the state of the light from the outside.
